(19) United States
(12) Patent Application Publication
(10) Pub. No.: US 2002/0167231 A1
(43) Pub. Date: Nov. 14, 2002

(54) Stator pole plate assemblies for D.C. brushless motors

(75) Inventors: Alex (Mr. Horng) Horng, Kaohsiung (TW); Ching-Shen Hong, Kaohsiung (TW); Tso-Kuo Yin, Kaohsiung Hsien (TW)

Correspondence Address: Bacon & Thomas, 4th Floor, 625 Slaters Lane, Alexandria, VA, 22314, US

(73) Assignee: Sunowealth Electric Machine Industry Co., Ltd., Kaohsiung (TW)

(21) Appl. No.: 09/852,043

(22) Filed: May 10, 2001

(51) Int. Cl. H02K 37/00; H02K 1/00

(52) U.S. Cl. 310/49 R; 310/216; 310/254

(57) ABSTRACT

A stator comprises a bobbin with a winding wound therearound and having a central hole. Pole plates are mounted to both sides of the bobbin. Each pole plate includes a plurality of poles and a central tubular portion. The poles of the pole plate attached to a side of the bobbin and the poles of the pole plate attached to the other side of the bobbin are alternately disposed. A magnetically conductive tube is extended through the central hole of the bobbin and the central tubular portions of the pole plates.

### BACKGROUND OF THE INVENTION

1. Field of the Invention

The present invention relates to stator pole plate assemblies for D.C. (direct current) brushless motors, and more particularly to stator pole plate assemblies having a lager area for magnetic conduction between magnetic pole plates and a magnetically conductive tube, thereby improving the magnetic conductibility of the line of the magnetic force.

2. Description of the Related Art

FIG. 1 of the drawings illustrates a conventional stator comprising a magnetically conductive tube 901 having an upper pole plate 902, a bobbin 903, and a lower pole plate 904 mounted therearound. Electric current is passed through a winding on the bobbin 903 to generate a magnetic field, and a passage of magnetic force is formed by the magnetically conductive tube 901, the upper pole plate 902, and the lower pole plate 904. End edges on the upper and lower pole plates 902 and 904 are in magnetic induction with a permanent ring magnet on a rotor to thereby drive the rotor. The thickness of each end edge of the upper and lower pole plates 902 and 904 forms an induction face for the magnetic induction with the permanent ring magnet. It was, however, found that the rotating torque is insufficient and the rotating speed is unstable, as the area of the induction face is relatively small.

U.S. patent application entitled “STATOR ASSEMBLY FOR A D.C. BRUSHLESS MOTOR” has been filed on Apr. 11, 2001 under serial No. ______ and discloses a stator assembly comprising a bobbin with a winding wound therearound. The bobbin includes an assembly hole through which a magnetically conductive tube extends. An upper pole plate and a lower pole plate are mounted to upper and lower sides of the bobbin, respectively. Each of the upper and lower pole plates has a plurality of poles. At least one upper magnetically conductive plate and at least one lower magnetically conductive plate are attached to the upper pole plate and the lower pole plate, respectively. Each of the upper magnetically conductive plate and the lower magnetically conductive plate includes a positioning hole through which the magnetically conductive tube extends. Each pole of at least one of the upper and lower pole plates and the upper and lower magnetically conductive plates includes a side wall that extends in a direction parallel to a longitudinal axis of the magnetically conductive tube. Since there are at least one upper magnetically conductive plate and at least one lower magnetically conductive plate that are respectively attached to the upper pole plate and the lower pole plate, the side walls and the permanent ring magnet of the rotor have a larger induction area therebetween. In addition, the upper magnetically conductive plate, the upper pole plate, the lower magnetically conductive plate, and the lower pole plate are stacked one another to increase the passage of magnetic force. Thus, the rotor outputs a larger rotating torque and rotates in a stabler manner without floating.

### SUMMARY OF THE INVENTION

It is the primary object of the present invention to provide stator pole plate assemblies having a lager area for magnetic conduction between magnetic pole plates and a magnetically conductive tube, thereby improving the magnetic conductibility of the line of the magnetic force.

A stator in accordance with the present invention comprises a bobbin with a winding wound therearound and having a central hole. Pole plates are mounted to both sides of the bobbin. Each pole plate includes a plurality of poles and a central tubular portion. The poles of the pole plate attached to a side of the bobbin and the poles of the pole plate attached to the other side of the bobbin are alternately disposed. A magnetically conductive tube is extended through the central hole of the bobbin and the central tubular portions of the pole plates.

Other objects, specific advantages, and novel features of the invention will become more apparent from the following detailed description and preferable embodiments when taken in conjunction with the accompanying drawings.

### BRIEF DESCRIPTION OF THE DRAWINGS

FIG. 1 is an exploded perspective view of a conventional stator.

FIG. 2 is an exploded perspective view of a first embodiment of a stator in accordance with the present invention.

FIG. 3 is a longitudinal sectional view of the positioning stator in FIG. 2.

FIG. 4 is an exploded perspective view of a second embodiment of the stator in accordance with the present invention.

FIG. 5 is an exploded perspective view of a third embodiment of the stator in accordance with the present invention.

FIG. 6 is a longitudinal sectional view of the stator in FIG. 5.

FIG. 7 is a longitudinal sectional view illustrating a fourth embodiment of the stator in accordance with the present invention.

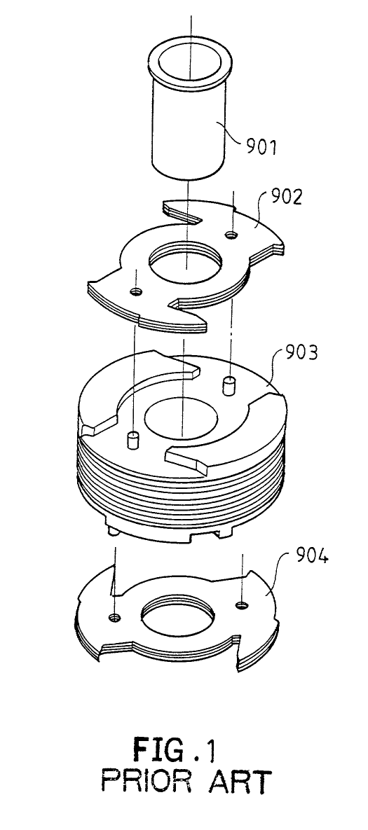

### DETAILED DESCRIPTION OF THE PREFERRED EMBODIMENTS

Preferred embodiments in accordance with the present invention will now be described with reference to the accompanying drawings.

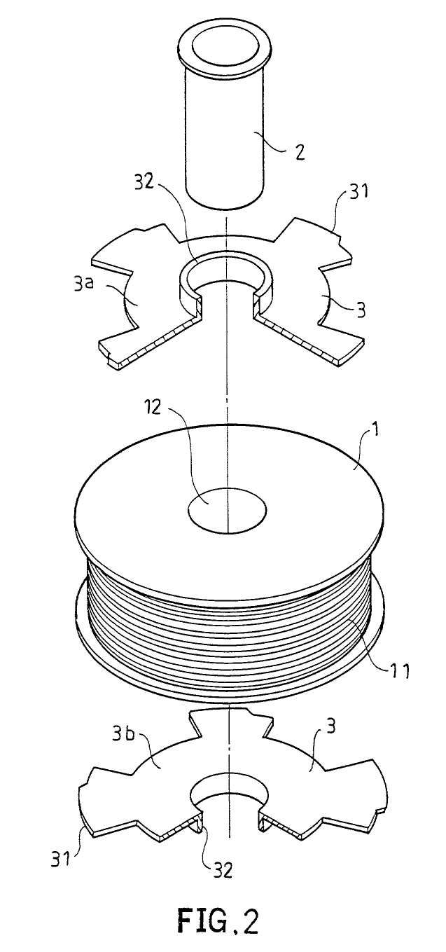

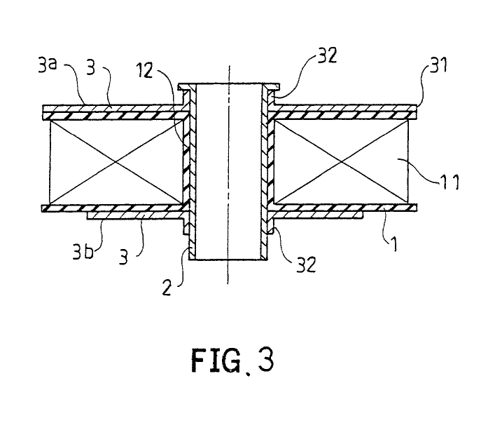

Referring to FIGS. 2 and 3, a stator in accordance with the present invention generally includes a bobbin 1, a magnetically conductive tube 2, and upper and lower pole plates 3.

The bobbin 1 may be of any conventional bobbin for all kinds of D.C. brushless motors and heat-dissipating fans. The bobbin 1 includes a winding 11 wound therearound and a central hole 12 through which the magnetically conductive tube 2 extends.

The magnetically conductive tube 2 is made from a magnetically conductive material, such as metal. The magnetically conductive tube 2 is extended through the upper and lower pole plates 3 and the central hole 12 of the bobbin 1. A flange 21 is formed on an end of the magnetically conductive tube 2 to prevent disengagement of the upper and lower pole plates 3.

The upper and lower plates 3 are made from a magnetically conductive material and include an upper pole plate 3a and a lower pole plate 3b attached to upper and lower ends of the bobbin 1, respectively. The upper pole plate 3a includes a central tubular portion 32 and a plurality of poles 31. Similarly, the lower pole plate 3b includes a central tubular portion 32 and a plurality of poles 31. The poles 31 of the upper pole plate 3a and the poles 31 of the lower pole plates 3b are alternately disposed. The central tubular portions 32 of the upper pole plate 3a and the lower pole plate 3b are aligned with the central hole 12 of the bobbin 1 to thereby allow the magnetically conductive tube 2 to extend therethrough. Thus, the pole plates 3 and the magnetically conductive tube 2 have a larger contact area therebetween and the passage of magnetic conduction between the pole plates 3 and the bobbin 2 is increased accordingly.

Referring to FIG. 3, in assembly, the upper pole plate 3a and the lower pole plate 3b are respectively attached to the upper side and the lower side of the bobbin 1 with the central tubular portions 32 of the upper and lower pole plates 3 (i.e., 3a and 3b) aligned with the central hole 12 of the bobbin 1. The magnetically conductive tube 2 is extended through the central tubular portions 32 of the upper and lower pole plates 3 and the central hole 12 of the bobbin 1. Thus, the pole plates 3 and the magnetically conductive tube 2 have a larger contact area therebetween and the passage of magnetic conduction between the pole plates 3 and the bobbin 2 is increased accordingly.

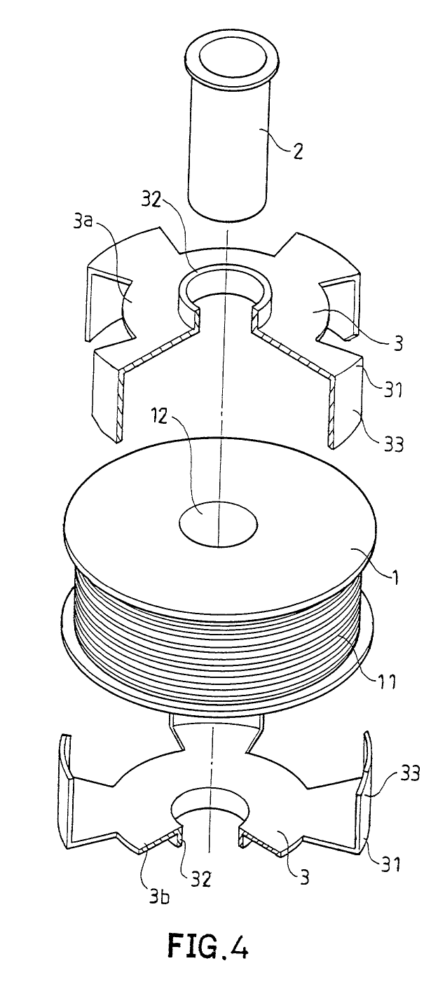

FIG. 4 illustrates a second embodiment of the stator in accordance with the present invention, wherein each pole 31 of the upper pole plate 3a and the lower pole plate 3b includes a longitudinal extension (not labeled) that extends in a direction parallel to a longitudinal direction of the magnetically conductive tube 2, thereby defining a magnetic pole face 33. It is noted that the magnetic pole faces 33 on the upper pole plate 3a and the magnetic pole faces 33 on the lower pole plate 3b are alternately disposed. In addition, the longitudinal extensions of the upper pole plate 3a extend downwardly and the longitudinal extensions of the lower pole plate extends upwardly. Thus, the stator includes magnetic pole faces 33 of larger area to thereby provide a better magnetic conductibility. In addition, when the magnetic pole faces 33 is in magnetic induction with the permanent ring magnet, the rotor outputs a higher rotating torque and rotates more stabler.

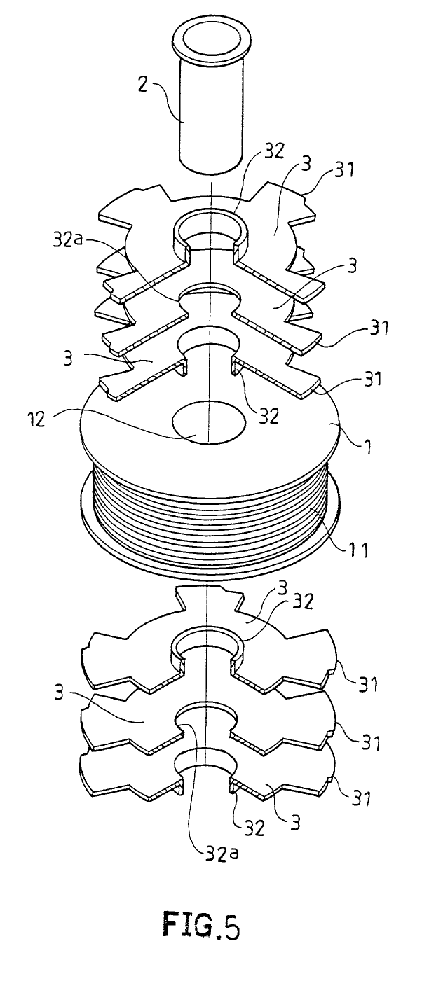

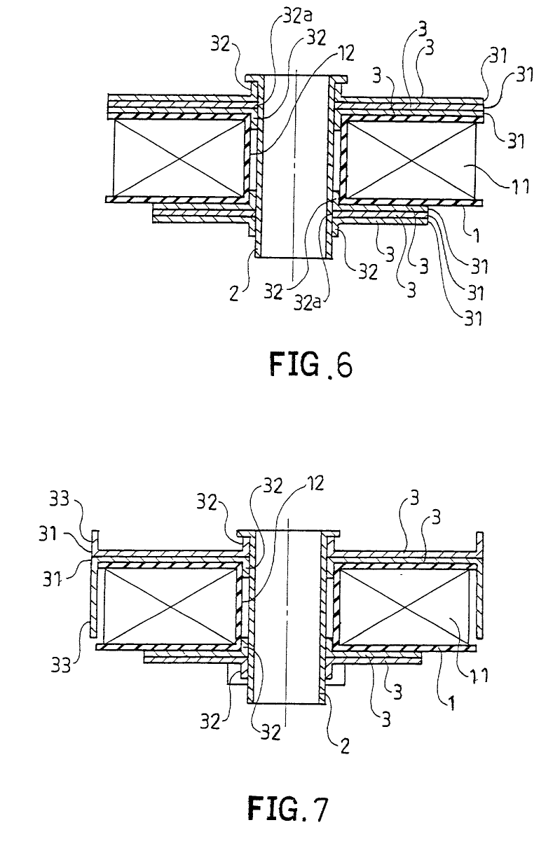

FIGS. 5 and 6 illustrate a third embodiment of the stator in accordance with the present invention, wherein at least two upper pole plates 3 are attached to an upper side of the bobbin 1 and at least two lower pole plates 3 are attached to a lower side of the bobbin 1. The poles 31 of the upper pole plates 3 are aligned with each other and the poles 31 of the lower pole plates 3 are aligned with each other. In addition, the poles of the upper pole plates 3 and the poles 31 of the lower pole plates 3 are alternately disposed.

The uppermost one of the upper pole plate 3 includes a central tubular portion 32 projecting from an upper side thereof and extending away from the bobbin 1. The lowermost one of the upper pole plate 3 includes a central tubular portion 32 projecting from an underside thereof and extending into the central hole 12 of the bobbin 1. The remaining upper pole plated 3 each includes a central hole 32a that is aligned with the central tubular portions 32 of the uppermost one and the lowermost one of the pole plates 3.

The lowermost one of the lower pole plate 3 includes a central tubular portion 32 projecting from an underside side thereof and extending away from the bobbin 1. The uppermost one of the lower pole plate 3 includes a central tubular portion 32 projecting from an upper side thereof and extending into the central hole 12 of the bobbin 1. The remaining lower pole plated 3 each includes a central hole 32a that is aligned with the central tubular portions 32 of the uppermost one and the lowermost one of the lower pole plates 3.

The central tubular portion 32 of the uppermost one of the lower pole plates 3 and the central tubular portion 32 of the lowermost one of the upper pole plates 3 extend into the central hole 12 of the bobbin 1. The magnetically conductive tube 1 is extended through the central tubular portions 32 and the central hole 32a of the upper and lower pole plates 3 as well as the central hole 12 of the bobbin 1, best shown in FIG. 6. As a result, the magnetically conductive tube 2 and the central tubular portions 32 of the upper and lower pole plates 3 have a larger contact area therebetween and the passage of magnetic conduction between the pole plates 3 and the bobbin 2 is increased accordingly.

FIG. 7 illustrates a fourth embodiment of the stator in accordance with the present invention. In this embodiment, two upper pole plates 3 are attached to the upper side of the bobbin 1 and two lower pole plates 3 are attached to the lower side of the bobbin 1. Each pole plate 3 includes a central tubular portion 32 and a plurality of poles 31. More specifically, the upper one of the upper pole plates 3 includes a central tubular portion 32 projecting from an upper side thereof and extending away from the bobbin 1. The lower one of the upper pole plates 3 includes a central tubular portion 32 projecting from an underside thereof and extending into the central hole 12 of the bobbin 1. The lower one of the lower pole plates 3 includes a central tubular portion 32 projecting from an underside thereof and extending away from the bobbin 1. The upper one of the lower pole plates 3 includes a central tubular portion 32 projecting from an upper side thereof and extending into the central hole 12 of the bobbin 1.

The poles 31 of the upper pole plates 3 are aligned with each other and the poles 31 of the lower pole plates 3 are aligned with each other. In addition, each pole 31 of the upper pole plate 3a and the lower pole plate 3b includes a longitudinal extension (not labeled) that extends in a direction parallel to a longitudinal direction of the magnetically conductive tube 2, thereby defining a magnetic pole face 33. Furthermore, the poles of the upper pole plates 3 and the poles 31 of the lower pole plates 3 are alternately disposed. The magnetically conductive tube 2 is extended through the central tubular portions 32 of the upper and lower pole plates 3 as well as the central hole 12 of the bobbin 1. As a result, the magnetically conductive tube 2 and the central tubular portions 32 of the upper and lower pole plates 3 have a larger contact area therebetween and the passage of magnetic conduction between the pole plates 3 and the bobbin 2 is increased accordingly. The stator includes magnetic pole faces 33 of a larger area to thereby provide a better magnetic conductibility. In addition, when the magnetic pole faces 33 is in magnetic induction with the permanent ring magnet, the rotor outputs a higher rotating torque and rotates more stabler.

According to the above description, it is appreciated that each pole plate of the stator in accordance wit the present invention includes a central tubular portion such that the magnetically conductive tube and the central tubular portions of the pole plates have a larger contact area when the magnetically conductive tube is extended through and thus connects the pole plates. The area of magnetic conduction between the pole plates and the magnetically conductive tube is increased, which increases the passage of magnetic conduction, thereby improving the magnetic conductibility.

Although the invention has been explained in relation to its preferred embodiment as mentioned above, it is to be understood that many other possible modifications and variations can be made without departing from the scope of the invention. It is, therefore, contemplated that the appended claims will cover such modifications and variations that fall within the true scope of the invention.

What is claimed is:

1. A stator for a D.C. brushless motor, comprising:
a bobbin including a winding wound therearound and a central hole;
a magnetically conductive tube made of a magnetically conductive material and extending through the central hole of the bobbin, the magnetically conductive tube including an upper side and a lower side;
at least one upper pole plate attached to the upper side of the magnetically conductive tube and including a plurality of poles and a central tubular portion through which the magnetically conductive tube extends; and
at least one lower pole plate attached to the lower side of the magnetically conductive tube and including a plurality of poles and a central tubular portion through which the magnetically conductive tube extends, the poles of said at least one upper pole plate and the poles of said at least one lower pole plate being alternately disposed.

2. The stator for a D.C. brushless motor as claimed in claim 1, wherein each said pole of said at least one upper pole plate and said at least one lower pole plate includes a longitudinal extension that extends in a direction parallel to a longitudinal direction of the bobbin, thereby defining a magnetic pole face.

3. The stator for a D.C. brushless motor as claimed in claim 1, wherein two said upper pole plates are attached to the upper side of the bobbin and two said lower pole plates are attached to the lower side of the bobbin, each of said upper pole plates and said lower pole plates including a central tubular portion through which the magnetically conductive tube extends.

4. The stator for a D.C. brushless motor as claimed in claim 3, wherein the central tubular portion of one of said upper pole plates extends into the central hole of the bobbin, the central tubular portion of one of said lower pole plates extending into the central hole of the bobbin.

5. The stator for a D.C. brushless motor as claimed in claim 4, wherein each said pole of one of said upper pole plates and said lower pole plates includes a longitudinal extension that extends in a direction parallel to a longitudinal direction of the bobbin, thereby defining a magnetic face.

6. The stator for a D.C. brushless motor as claimed in claim 1, wherein two said upper pole plates are attached to the upper side of the bobbin and two said lower pole plates are attached to the lower side of the bobbin, an upper one of the two upper pole plates including a central tubular portion projecting from an upper side thereof and extending away from the bobbin, a lower one of the two upper pole plates including a central tubular portion projecting from an underside thereof and extending into the central hole of the bobbin, an upper one of the two lower pole plates including a tubular portion projecting from an upper side thereof and extending into the central hole of the bobbin, a lower one of the two lower pole plates including a tubular portion projecting from an underside thereof and extending away from the bobbin, the magnetically conductive tube being extending through the central tubular portions of the upper pole plates and the lower pole plates.

7. The stator for a D.C. brushless motor as claimed in claim 6, wherein each of the poles of the upper one of the upper pole plates includes a longitudinal extension extending along a longitudinal direction of the magnetically conductive tube and extending away from the lower pole plates, each of the poles of the lower one of the lower pole plates including a longitudinal extension extending along the longitudinal direction of the magnetically conductive tube and extending toward the lower pole plates.

8. The stator for a D.C. brushless motor as claimed in claim 6, further comprising at least one further upper pole plate sandwiched between the two upper pole plates, said at least one further upper pole plate including a central hole through which the magnetically conductive tube extends.

9. The stator for a D.C. brushless motor as claimed in claim 1, wherein the magnetically conductive tube includes a flange on an end thereof to prevent disengagement of said at least one upper pole plate and said at least one lower pole plate.

10. The stator for a D.C. brushless motor as claimed in claim 2, wherein the magnetically conductive tube includes a flange on an end thereof to prevent disengagement of said at least one upper pole plate and said at least one lower pole plate.

11. The stator for a D.C. brushless motor as claimed in claim 6, wherein the magnetically conductive tube includes a flange on an end thereof to prevent disengagement of said at least one upper pole plate and said at least one lower pole plate.

12. The stator for a D.C. brushless motor as claimed in claim 7, wherein the magnetically conductive tube includes a flange on an end thereof to prevent disengagement of said at least one upper pole plate and said at least one lower pole plate.

13. The stator for a D.C. brushless motor as claimed in claim 8, wherein the magnetically conductive tube includes a flange on an end thereof to prevent disengagement of said at least one upper pole plate and said at least one lower pole plate.
